(19) United States
(12) Patent Application Publication
(10) Pub. No.: US 2004/0223312 A1
(43) Pub. Date: Nov. 11, 2004

(54) Light source mechanism of scanner

(75) Inventors: Wei-Hsiang Huang, Miao-Li Hsien (TW); Yu-Shan Chang, Tai-Chung City (TW)

Correspondence Address: LOWE HAUPTMAN GILMAN & BERNER, LLP, Suite 310, 1700 Diagonal Road, Alexandria, VA, 22314, US

(73) Assignee: VEUTRON CORPORATION

(21) Appl. No.: 10/428,830

(22) Filed: May 5, 2003

(51) Int. Cl. F21V 7/04

(52) U.S. Cl. 362/31; 362/247

(57) ABSTRACT

The light source mechanism of a scanner provided in the present invention is to provide a plurality of light-emitting diodes that are placed uniformly beside a light-guide panel. The light emitted from the light-emitting diodes further passes through the light-guide panel, and is incident onto the scanning platform. Since the light-emitting diodes are uniformly placed beside the scanning platform, the brightness of the light incident onto the scanning platform is more uniform than that of the prior art using a line type light source such as a CCFL (Cold Cathode Fluorescent Lamp) of a scanner, hence the light source mechanism provided in the present invention achieves a better image scanning with a remaining cost of a scanner

### BACKGROUND OF THE INVENTION

1. Field of the Invention

The present invention relates to a light source mechanism utilized in a scanner, and more particularly, to an embedded-type light-emitting diode (LED) utilized in a scanner.

2. Description of the Prior Art

A scanner scans films or documents to import the image signal captured therefrom into a computer or storage devices. Scanners can be classified to reflection-type scanners and transmission-type scanners. Because the transparent manuscripts cannot reflect light well, the reflection-type scanner cannot scan the transparent manuscripts well. Therefore, the transmission-type scanner is used to scan the transparent manuscripts.

A scanner comprises a light source, a light-guide panel, a light diffusing panel, an optic-electronic transfer device, a scan-moving motor, a motherboard, a housing and some other components. The light source emits light to reflection manuscripts or transparent manuscripts. The optic-electronic transfer device collects the light reflected from and passed through the manuscripts to transfer the corresponding electronic signals into the motherboard. Because a reflection-type scanner emits light from a light source to manuscripts on one side of manuscripts, and then an optic-electronic transfer device collects light reflected from manuscripts on the same side of the manuscripts, the light source and the optic-electronic transfer device can be mounted on the same side of the manuscripts. A transmission-type scanner emits light from a light source to manuscripts on one side of manuscripts, but an optic-electronic transfer device of the transmission-type scanner has to collect light passing through the manuscripts on the other side of the manuscripts. It means that the light source of the transmission-type scanner has to be mounted on different side of the manuscripts from the optic-electronic transfer device of the transmission-type scanner for completing scanning, and the structure of a transmission-type scanner is different from the structure of the reflection-type scanner.

As shown in FIG. 1, the light source, such as a CCFL (cold cathode fluorescent lamp) 12 of a normal scanner in the prior art, is mounted along a side of the light-guide panel 14 of the scanner for emitting light into the light-guide panel 14. A following light diffusing panel 16 is mounted below the light-guide panel 14 for making the light, passing through the light-guide panel 14, uniform to emit the transparent scanning platform 18 throughout. Because the light reflected from or passing through manuscripts (not shown) identify the nature of the area on the manuscripts, if the light is not uniform enough, the optic-electronic transfer device (not shown) that collects the light reflected from or passing through the manuscripts will collect error image signal that is utterly different with the nature of the area on the manuscripts.

As shown in FIG. 1, when a CCFL 12, as the light source, is mounted along the light-guide panel 14, the area on the transparent scanning platform 18 near the CCFL 12 is brighter than the area farther. Even if the light diffusing panel 16 is used for making the brightness of the light on the transparent scanning platform 18 uniform, the light still cannot diffuse perfect on the transparent scanning platform 18.

An improvement of the prior art is to mount another CCFL (not shown) opposite to the former CCFL 12 for compensating the brightness on the transparent scanning platform. Even though the improvement makes effectiveness, the improvement is not perfect as maintaining the cost of a scanner for adding the second CCFL.

Therefore, it is necessary to improve the light source mechanism for producing an uniformly diffusion on the transparent scanning platform 18 on the premise that the cost of the scanner maintains less.

### SUMMARY OF THE INVENTION

According to the above description of the background of the invention, it is one objective of the present invention to provide a plurality of light-emitting diodes in place of a CCFL (cold cathode fluorescent lamp) as a light source of a scanner.

It is another object of the present invention to provide a plurality of light-emitting diodes as a plane-like light source of a scanner in place of a line-shaped light source used in the prior art.

It is a further objective of the present invention to provide a plurality of light-emitting diodes as a light source of a scanner to emit light more uniform to the transparent scanning platform and improve the quality of the scanner without increasing cost of the scanner.

It is a further objective of the present invention to reduce the size of a scanner with a plurality of light-emitting diodes as a light source. The size of the line-type light source (such as a CCFL or a halo-light) of the scanner in prior art is bigger than the light-emitting diodes using in the present invention so the size of a scanner in the present invention is smaller than a scanner in the prior art. Furthermore, because the light-emitting diodes can be embedded in the light-guide panel, the size of the scanner in the present invention can be much smaller.

It is a further objective of the present invention to reduce heat problems of a scanner with a plurality of light-emitting diodes as a light source. Because the light-emitting diodes operate with less calorific capacity than a line-type light source (such as a CCFL or a halo-light) does, the calorific capacity produced by the light source in the present invention shouldn't interfere with the scanner operation in the present invention.

It is a further objective of the present invention to economize cost of a device and mental capability of a designer to reduce heat problems of a scanner with the light-emitting diodes as a light source. Because the light-emitting diodes operate with less calorific capacity, the designer of the present scanner has little demand to design the reducing-calorific-capacity device of the light source, and cost of a device for reducing heat problems can be economized.

It is a further objective of the present invention to increasing using-variations for users when users use the present scanner. Because the designer of the present scanner can design a system to decide which light-emitting diode be turned on or not. For example, if there are sixteen light-emitting diodes configured inside a scanner as a light source, the user can scan a manuscript by any number of light-emitting diodes between 1˜16 as the user wants (as 8, 2, 5, or 10 . . . ). Furthermore, the user can choose different permutation of light-emitting diodes according to the size of manuscripts for saving energy or some special vision-impression of manuscripts that the user wants.

The light source mechanism such as light-emitting diodes that is placed uniformly beside a light-guide panel of a scanner provided in the present invention replaces a line-like light source that is placed along a light-guide in the prior art.

A designer of a scanner in the present invention may further make the light emitted from the described light-emitting diodes passing through a light-guide panel and/or the light diffusing panel before the light incident onto the transparent scanning platform, in order to make the brightness onto the transparent scanning platform uniform. The designer may mount a plurality of panel reflectors around the light-guide panel to prevent the light from vanishing in any direction that is not toward the transparent scanning platform for utilizing the light emitted from the source more efficient.

Because the light-emitting diodes are mounted uniformly over the transparent scanning platform, the light incident onto the transparent scanning platform is a plane-like light, hence the brightness of the light on the transparent scanning platform is more uniform in the present invention than that in the prior art. Therefore, the image of the scanning in the present invention is improved without raising the cost of the scanner.

### BRIEF DESCRIPTION OF THE DRAWINGS

FIG. 1 shows the light source of a film scanner in the prior art;

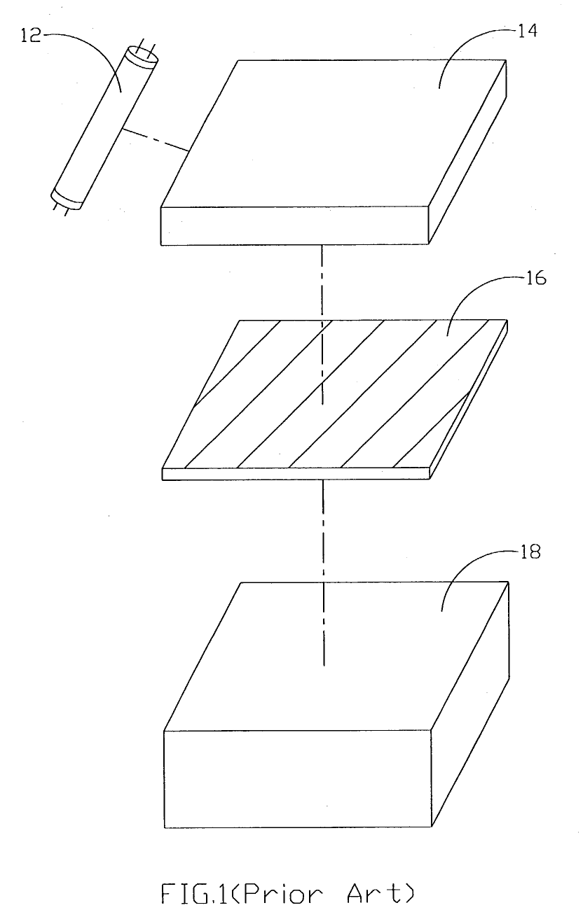

FIG. 2 shows the lateral view of the first preferred embodiment provided in the present invention;

FIG. 3 shows the embedded light-emitting diodes and the light-guide panel provided in the present invention;

FIG. 4 shows the view of the light-emitting diodes from the direction of the transparent scanning platform;

FIG. 5 shows the relative position of the light-guide panel and the light diffusing panel; and

FIG. 6 shows the lateral view of the second preferred embodiment provided in the present invention.

### DESCRIPTION OF THE PREFERRED EMBODIMENT

A preferred embodiment of the present invention that provides a light source mechanism of a plurality of light-emitted diodes of a scanner in the present invention will now be described in greater detail. Nonetheless, it should be recognized that the present invention can be practiced in a wide range of other embodiments besides those explicitly described, and the scope of the present invention is expressly not limited except as specified in the accompanying claims.

The light source mechanism of a scanner provided in the present invention comprises a plurality of light-emitting diodes as light source of the scanner, wherein the light-emitting diodes are uniformly embedded into the light-guide panel, not arranged in a line along the side of the light-guide panel.

The light emitted from the described light-emitting diodes may further pass through the light-guide panel and/or the light diffusing panel before incident onto the transparent scanning platform. In addition, we may mount a plurality of panel reflectors around the light-guide panel to prevent the light from vanishing in any direction that is not toward the transparent scanning platform for utilizing the light emitted from the source more efficient.

Since the light-emitting diodes are mounted uniformly in a transparent scanning platform, the light incident onto the scanning platform is plane-like. Hence the brightness on the transparent scanning platform in the present invention is more uniform than that in the prior art that uses a CCFL as a light source of a scanner. The cost of a scanner in the present invention is not expensive than the cost of a scanner in the prior art.

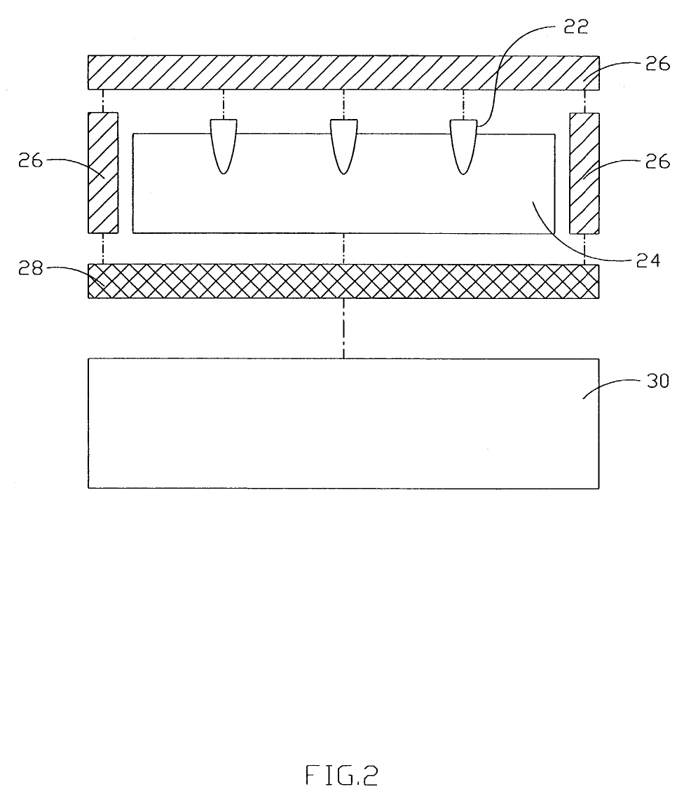

The preferred embodiment of light-emitting diodes embedded scanner provided in the present invention is shown in FIG. 2. The scanner comprises light-emitting diodes 22, a light-guide panel 24 with a plurality of embedding holes, a plurality of panel reflectors 26, a light diffusing panel 28, and a transparent scanning platform 30. The light-emitting diodes 22 are embedded and fixed into the embedding holes of the light-guide panel 24. When a user scans a manuscript (not shown), the manuscript is placed on the transparent scanning platform 30.

The light-guide panel 24 embedded with light-emitting diodes 22 is mounted aside the transparent scanning platform 30. As shown in FIG. 2, a light diffusing panel 28 is mounted between the transparent scanning platform 30 and the light-guide panel 24 to make the brightness onto the transparent scanning platform 30 more uniform. Furthermore, panel reflectors 26 are mounted around the light-guide panel 24 except the surface that is directly toward the transparent scanning platform 30, in order to prevent the light that is emitted in the direction un-toward the transparent scanning platform 30 from vanishing.

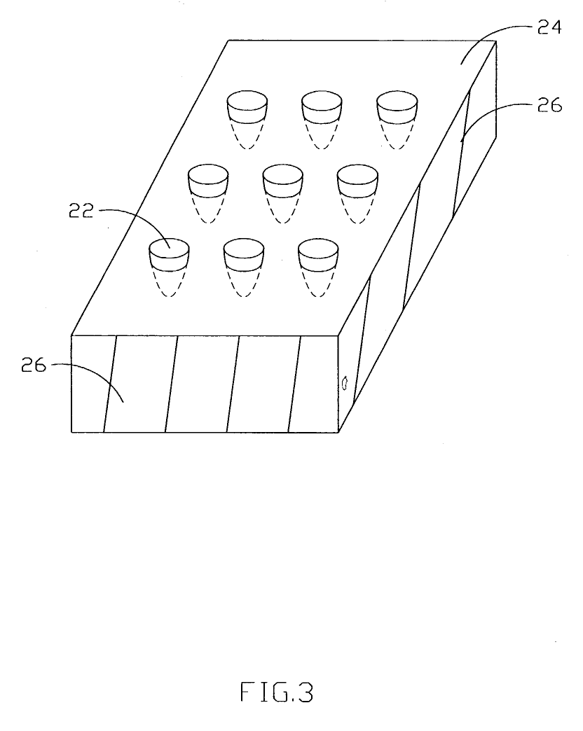

FIG. 3 shows the embedded light-emitting diodes 22 and the light-guide panel 24 provided in the present invention. The light-emitting diodes 22 are embedded in embedding holes that are plane-distributive in the light-guide panel 24. The light-guide panel 24 are mounted around the panel reflectors 26 except the surface that is directly toward the transparent scanning platform 30, to prevent the light that is emitted untowards the transparent scanning platform 30 from vanishing, as mentioned above, and to utilize the light more efficiently.

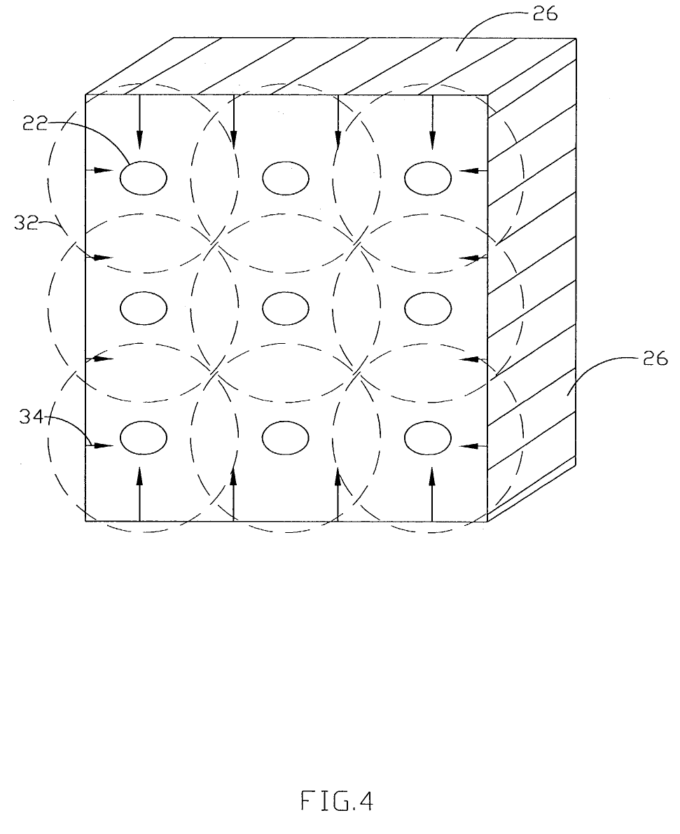

FIG. 4 shows the view of the embedded light-emitting diodes 22 from the direction of the transparent scanning platform 30. The light-emitting diodes 22 are embedded uniformly into the light-guide panel 24. In the first prefer embodiment, the number of light-emitting diodes 22 is nine, as show in FIG. 4. The number of light-emitting diodes used in the present invention depends on budget and demand, not limited to the scope of patent in the present invention. Each circle 32 shows the light-distribution of each light-emitting diode 22. Since each light-distribution of each light-emitting diode 22 overlaps with each other, the entire light-distribution of the entire light-emitting diodes 22 are uniformly compensated to form a plane-like distribution. Compared with the prior art, a scanner using a line-like light source as a CCFL, the present invention provides a better light distribution. The panel reflectors 26 reflect the light emitted from the light-emitting diodes 22 as arrows 34 to utilize the light more efficient.

The panel reflectors 26 make the distribution of the light more uniform. According to geometric optics, they are imaginary sources when the light reflected from the panel reflectors 26, and each imaginary source corresponds to a light-emitting diode 22. The light-emitting diodes 22 and the corresponding imaginary sources establish a uniform light field, and the transparent scanning platform 30 is placed inside the uniform light field. As a result, the brightness on the transparent scanning platform 30 with the panel reflectors 26 is more uniform than that without the panel reflectors 26.

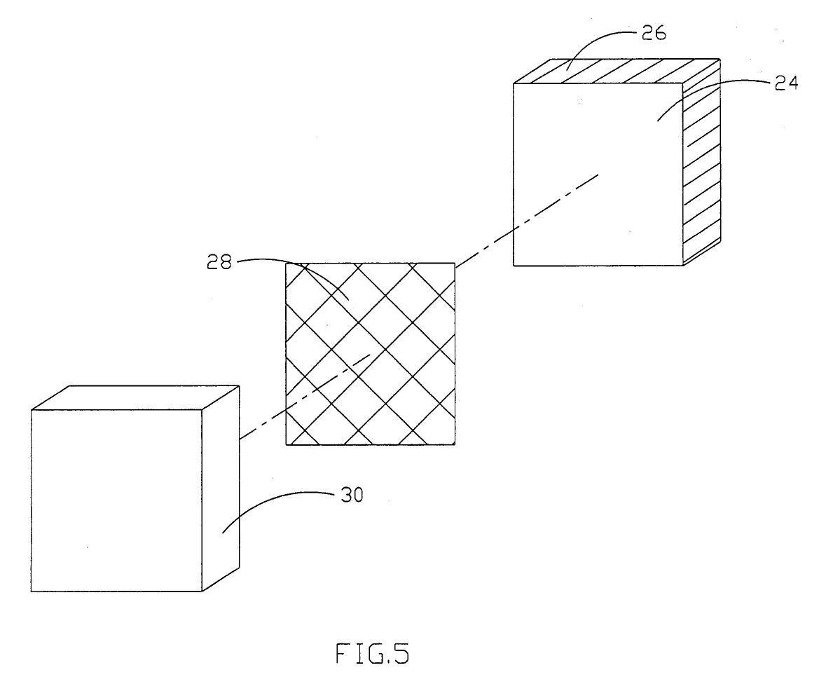

As shown in FIG. 5, the present scanner designer can design a light diffusing panel 28 to make the light emitted into the transparent scanning platform 30 more uniform between the light-guide panel 24 and the transparent scanning platform 30.

Besides, a present scanner designer can design a system to decide which light-emitting diode be turned on or not. For example, if there are sixteen light-emitting diodes configured inside a scanner as a light source, the user can scan a manuscript by any number of light-emitting diodes between 1˜16 as the user wants. Furthermore, the user can choose different permutation of light-emitting diodes according to the size of manuscripts for saving energy or some special vision-impression of manuscripts that the user wants.

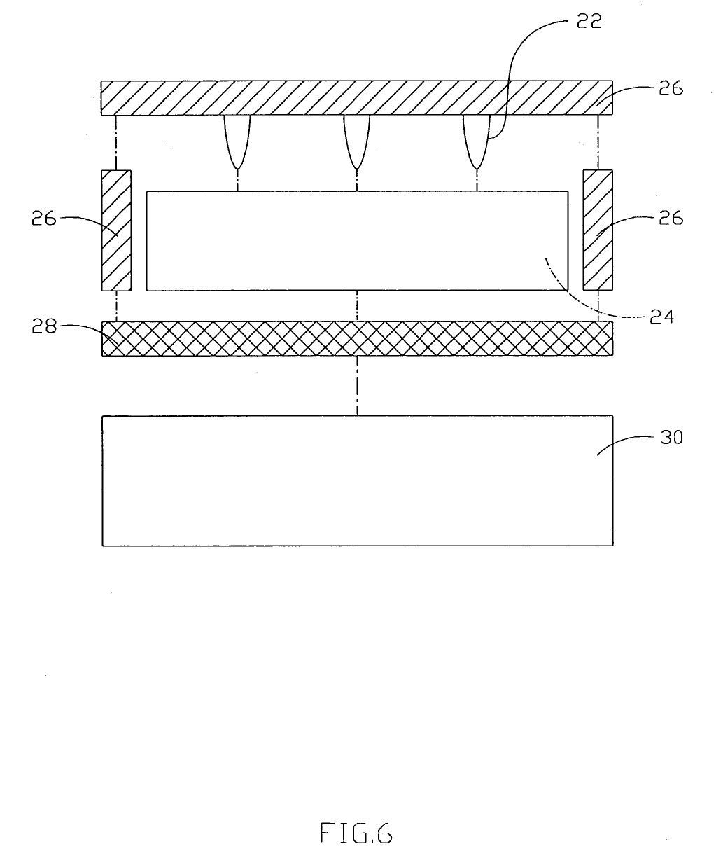

As shown in FIG. 6, is the second embodiment, the light-emitted diodes 22 are uniformly fastened on a panel reflector 26 which is parallel with the light-guide panel 24. The light source of the second embodiment is different with a line-like light source of the prior art or a plane-like light source that are embedded uniformly into the light-guide panel 24, it is fastened on a panel reflector.

Compared with the prior art using a CCFL as light source of a scanner, the present LED-embedded scanner has a better and more uniform light source, and the improvement not only makes the bright uniform without adding an additional CCFL, but also remains the cost of a scanner.

The size of a scanner with a plurality of light-emitting diodes as a light source in the present invention is smaller then the size of a scanner in the scanner with a line-type light source in the prior art. The size of the line-type light source (such as a CCFL or a halo-light) of the scanner in the prior art is bigger than the size of light-emitting diodes using in the present invention so the size of a present scanner is smaller than the size of a prior scanner. Furthermore, because the light-emitting diodes can be embedded in the light-guide panel, the size of the scanner in the present invention can be much smaller.

Because the light-emitting diodes operate with less calorific capacity than a line-type light source (such as a CCFL or a halo-light) does, the calorific capacity produced by the light source in the present invention shouldn't interfere with the scanner operation in the present invention.

Because the light-emitting diodes operate with less calorific capacity, the designer of the present scanner has little demand to design the reducing-calorific-capacity device of the light source, and cost of a device for reducing heat problems can be economized.

Because the designer of the present scanner can design a system to decide which light-emitting diode be turned on or not. For example, if there are sixteen light-emitting diodes configured inside a scanner as a light source, the user can scan a manuscript by any number of light-emitting diodes between 1˜16 (as 8, 2, 5, or 10 . . . ) as the user wants. Furthermore, the user can choose different permutation of light-emitting diodes according to the size of manuscripts for saving energy or some special vision-impression of manuscripts that the user wants.

The described above is only to demonstrate and illustrate the preferred embodiments of the present invention, not to limit the scope of the present invention to what described detailed herein; and any equivalent variations and modifications in the present invention should be within the scope of the claims hereafter.

1. A light source mechanism which is used for a scanner, comprising:
a light-guide panel including a first transparent plane;
a plurality of illuminants, said illuminants being fastened uniformly near by said first transparent plane of said light-guide panel.

2. The light source mechanism according to claim 1, further comprising illuminants being embedded into a side of said light-guide panel, said side being perpendicular to said first transparent plane of said light-guide panel.

3. The light source mechanism according to claim 2, wherein said illuminants are embedded in a form of plane-distributive array.

4. The light source mechanism according to claim 1, further comprising a panel reflector to reflect said light illuminated from said illuminants on a manuscript.

5. The light source mechanism according to claim 4, wherein said first transparent plane parallels said manuscript

6. The light source mechanism according to claim 4, wherein partial said panel reflector parallels said first transparent plane of said light-guide panel for fastening said illuminants.

7. The light source mechanism according to claim 1, further comprising a panel reflector that parallels said first transparent plane of said light-guide panel for fastening said illuminants.

8. The light source mechanism according to claim 1, wherein each said illuminant is placed near to each other at the same distance.

9. The light source mechanism according to claim 1, further comprising a light diffusing panel to make the light uniform incident on a scanning platform, and be placed between said scanning platform and said light-guide panel.

10. The light source mechanism according to claim 1, wherein each said illuminant is controllably turned on or off.

11. A light source mechanism which is used for a scanner, comprising:
a light-guide panel including a first transparent plane and a plurality of holes being dug on said first transparent plane;
a plurality of illuminants, said illuminants being embedded inside said holes on said first transparent plane of said light-guide pane.

12. The light source mechanism according to claim 11, wherein said holes are dug on said first transparent plane in the form of plane-distributive array.

13. The light source mechanism according to claim 11, wherein each said illuminant is placed near to each other at the same distance.

14. The light source mechanism according to claim 11, further comprising a panel reflector to reflect said light illuminated from said illuminants on a manuscript.

15. The light source mechanism according to claim 14, wherein said first transparent plane parallels said manuscript.

16. The light source mechanism according to claim 11, wherein each said illuminant is controllably turned on or off.
